(19) United States
(12) Patent Application Publication
(10) Pub. No.: US 2020/0376442 A1
(43) Pub. Date: Dec. 3, 2020

(54) GRAPHENE OXIDE MEMBRANE PROTECTIVE COATING

(71) Applicant: NITTO DENKO CORPORATION, Osaka (JP)

(72) Inventors: Shijun Zheng, San Diego, CA (US); Weiping Lin, Carlsbad, CA (US); John Ericson, La Palma, CA (US); Isamu Kitahara, San Diego, CA (US); Ozair Siddiqui, Murrieta, CA (US); Wan-Yun Hsieh, San Diego, CA (US); Peng Wang, San Diego, CA (US); Yuji Yamashiro, Osaka (JP); Craig Roger Bartels, San Diego, CA (US); Makoto Kobuke, Osaka (JP)

(21) Appl. No.: 16/955,007

(22) PCT Filed: Dec. 20, 2018
(86) PCT No.: PCT/US2018/066780

§ 371 Date: Jun. 17, 2020

Related U.S. Application Data
(60) Provisional application No. 62/609,110, filed on Dec. 21, 2017.
(60) Provisional application No. 62/746,480, filed on Oct. 16, 2018.

(51) Int. Cl. B01D 67/00; B01D 61/02; B01D 65/08; B01D 71/56; B01D 71/02; B01D 69/12; C02F 1/44

(52) U.S. Cl. CPC B01D 67/0093; B01D 61/025; B01D 65/08; B01D 71/56; B01D 71/021; B01D 71/024; C02F 2103/08; B01D 69/12; C02F 1/441; B01D 2323/30; B01D 2313/23; B01D 2323/36; B01D 67/0079

(57) ABSTRACT

Described herein are protective coatings for reverse osmosis membranes comprising coating mixtures of graphene oxide crosslinked with copolymers. The crosslinked GO copolymer mixture coatings provide protection from chlorine-based defoulers of saline water and unprocessed fluids. The coated membranes described herein create a reverse osmosis structure that has excellent water flux and salt rejection. The crosslinking copolymers can comprise an optionally substituted vinyl imidazole constituent unit and an optionally substituted acrylic amide constituent unit.

### CROSS-REFERENCE TO RELATED APPLICATIONS

This application claims the benefit of U.S. Provisional Application No. 62/609,110, filed Dec. 21, 2017 and U.S. Provisional Application No. 62/746,480, filed Oct. 16, 2018, both of which are incorporated by reference herein in their entirety.

### BACKGROUND

### Field

The present disclosure describes coated reverse osmosis membranes for the desalination of salt water solutions or for water purification. The membranes are typically polyamides and the coatings comprise graphene oxide and a crosslinking polymer.

### Description of Related Art

Due to the increase in human population, and the corresponding demand for safe drinking water, there has been vigorous interest in new technologies for the desalination of sea water and purification of waste water streams. Reverse osmosis membranes are currently the state of the art for the generation of potable water from saline water. Still, these membranes suffer from various shortcomings. Most of current commercial reverse osmosis membranes adopt a thin-film composite (TFC) configuration consisting of a thin aromatic polyamide selective layer on top of a microporous substrate, typically a polysulfone membrane on non-woven polyester. Although these membranes can provide excellent salt rejection and high water flux, thinner and more hydrophilic membranes are still desired to improve energy efficiency of reverse osmosis processes.

Typical reverse osmosis membranes can be compromised by fouling resulting from algae growth, which causes decrease of water flux and higher energy consumption. One current response to this biofouling was been to incorporate chlorine or chloramine into the aqueous feed solution in order to suppress the growth of biological species on the reverse osmosis membrane surface. Unfortunately, chlorine and chloramine, even in the low levels at which they are used, are detrimental to the reverse osmosis membrane structure and cause decreases of salt rejection and water flux. Therefore, a reverse osmosis membrane structure with enhanced chlorine resistance properties is desirable.

### SUMMARY

The present disclosure describes reverse osmosis structures which contain a crosslinked graphene oxide (GO) coated polyamide membrane that is resistant to degradation due to chlorine and chloramine.

Some embodiments include a reverse osmosis membrane structure, comprising: a membrane comprising a polyamide layer; and a composite coating disposed upon the membrane; wherein the composite coating comprises a crosslinked graphene oxide which is a product of reacting a mixture comprising a graphene oxide and a copolymer crosslinker; and wherein the copolymer crosslinker comprises at least an optionally substituted vinyl imidazolyl constituent unit and an optionally substituted acrylic amide constituent unit.

Some embodiments include a method of desalinating water comprising applying a saline water to a membrane described herein, wherein the saline water comprises a salt and water, wherein the saline water is applied to the membrane so that some of the water passes through the membrane to yield water with a lower salt content.

These and other embodiments are described in greater detail below.

### BRIEF DESCRIPTION OF THE DRAWINGS

FIG. 1 is a diagram showing the dimensions of a graphene platelet.

FIG. 2 is a depiction of a possible embodiment of a coated membrane with a protective coating.

FIG. 3 is a XPS spectra depicting atomic composition of an embodiment of the GO-PAAVA (CLC-1) polymer described herein, before soaking in chlorine, C1S as a function of binding energy (eV).

FIG. 4 is a XPS spectra depicting atomic composition of an embodiment of the GO-PAAVA (CLC-1) polymer described herein, after soaking in chlorine, C1S as a function of binding energy (eV).

FIG. 5 is a graph depicting the salt rejection (%) as a function of chlorine exposure time (hours) of a comparative example (CE-1) and embodiments (CLC-5, GO-PAVAL) described herein.

FIG. 6 is a graph depicting the salt rejection (%) as a function of chlorine exposure time (hours) of a feed solution of treated waste water as applied to comparative example (CE-1) and embodiments (GO-PAVAS) (CLC-4) and (GO-PAAVA) (CLC-1) described herein.

FIG. 7 is a graph depicting the flux (GPD) as a function of chlorine exposure time (hours) of a comparative example (CE-1) and embodiments (GO-PAVAS) (CLC-4) and (GO-PAAVA) (CLC-1)

### DETAILED DESCRIPTION

Emerging graphene materials have many desirable properties. Among these is a 2-dimensional sheet-like structure having nanometer scale thickness and extraordinary mechanical strength. Graphene oxide, prepared from the exfoliative oxidation of graphite, can be mass produced at low cost. Graphene oxide is unique in that it contains oxygen groups on its surface that can readily react with various nucleophiles to create a more functionalized surface. The oxygen groups of GO are generally hydroxyl groups or epoxide groups which can react with a variety of molecules including but not limited to amines, amides, alcohols, carboxylic acids, and sulfonic acids. Unlike traditional membranes, where the water is transported through the pores of the material, in graphene oxide membranes the transportation of water can be between the interlayer spaces. Graphene oxide's capillary effect can result in long water slip lengths that offer fast water transportation rates. Additionally, the GO membrane's selectivity and water flux can be tuned by manipulating the interlayer distance of graphene sheets. In some cases, this manipulation is accomplished by crosslinking. In addition, the surface of graphene oxide contains a large number of carbon-carbon double bonds, which can chemically react with and absorb chlorine and chloramine.

It is believed that there may be a large number (^{˜}30%) of hydroxyl groups on the basal plane of GO, which may be readily reactive with nucleophiles, such as carboxylic and/or sulfonic acid groups at elevated temperatures. It is also believed that GO sheets may have an extraordinary high aspect ratio which provides a large available gas/water diffusion surface over that of other materials and has the ability to decrease the effective pore diameter of any substrate supporting material to minimize contaminant infusion while retaining flux rates.

The present disclosure relates to water separation membrane structures for reverse osmosis applications. Membrane structures in conjunction with a highly hydrophilic coating having low organic compound permeability, while maintaining high mechanical and chemical stability, may be useful for water purification purposes. Polyamide membranes and/or membrane elements such as salt rejection layers are potentially useful in combination with the coating.

The coated membrane structure may be suitable for the desalination of seawater or purification of unprocessed fluids. The coated membrane structure may be useful for solute removal from an unprocessed fluid, for example in waste water treatment. The coated membrane structure may be suitable for fluid streams having been exposed to chlorinated solutions useful in antifouling. The coated membrane structure may be useful in the dehydration or water/water vapor removal from an unprocessed fluid. In some embodiments, a coating layer comprising graphene oxide and a copolymer crosslinker are described. In some examples, the membrane structure may have a high rate of water flux. In some embodiments, the membrane structure may have a high level of salt rejection. In some embodiments, the membrane structure can chemically absorb chlorine and resist degradation.

Some embodiments herein include a polyamide membrane that is coated with a composite coating, for treatment of unprocessed fluids and the desalination of saline water. The reverse osmosis structures described herein have a polyamide layer and composite coating that, when in use, are in fluid communication with the feed aqueous solution.

The composite coating comprises a crosslinked graphene oxide which is a product of reacting a mixture comprising a graphene oxide and a copolymer crosslinker.

Typically, the copolymer crosslinker contains a combination of constituent units, such as an optionally substituted vinyl imidazolyl constituent unit and an optionally substituted acrylic amide constituent unit.

Unless otherwise indicated, when a compound or chemical structural feature such as graphene oxide or copolymer is referred to as being “optionally substituted,” it includes a feature that has no substituents (i.e., unsubstituted), or a feature that is “substituted,” meaning that the feature has one or more substituents. The term “substituent” has the broadest meaning known to one of ordinary skill in the art, and includes a moiety that replaces one or more hydrogen atoms attached to a parent compound or structural feature. In some embodiments, a substituent may be an ordinary organic moiety known in the art, which may have a molecular weight (e.g., the sum of the atomic masses of the atoms of the substituent) of 15-50 g/mol, 15-100 g/mol, 15-150 g/mol, 15-200 g/mol, 15-300 g/mol, or 15-500 g/mol. In some embodiments, a substituent comprises, or consists of: 0-30, 0-20, 0-10, or 0-5 carbon atoms; and 0-30, 0-20, 0-10, or 0-5 heteroatoms, wherein each heteroatom may independently be: N, O, S, Si, F, Cl, Br, or I; provided that the substituent includes one C, N, O, S, Si, F, Cl, Br, or I atom. Examples of substituents include, but are not limited to, alkyl, alkenyl, alkynyl, heteroalkyl, heteroalkenyl, heteroalkynyl, aryl, heteroaryl, hydroxy, alkoxy, aryloxy, acyl, acyloxy, alkylcarboxylate, thiol, alkylthio, cyano, halo, thiocarbonyl, O-carbamyl, N-carbamyl, O-thiocarbamyl, N-thiocarbamyl, C-amido, N-amido, S-sulfonamido, N-sulfonamido, isocyanato, thiocyanato, isothiocyanato, nitro, silyl, sulfenyl, sulfinyl, sulfonyl, haloalkyl, haloalkoxyl, trihalomethanesulfonyl, trihalomethanesulfonamido, amino, etc.

For convenience, the term “molecular weight” is used with respect to a moiety or part of a molecule to indicate the sum of the atomic masses of the atoms in the moiety or part of a molecule, even though it may not be a complete molecule.

As used herein the term “Cₓ-C_{y}” or “C_{X-Y}” refers to a hydrocarbon chain having from X to Y carbon atoms. For example, C₁-C₁₂ hydrocarbyl or C₁₋₁₂ hydrocarbyl includes hydrocarbons containing 1, 2, 3, 4, 5, 6, 7, 8, 9, 10, 11, or 12 carbon atoms.

As used herein the term “fluid” means any substance that continually deforms, or flows, under an applied shear stress, such as gases, liquids, and/or plasmas.

As used herein, the term “fluid communication” means that the individual components, membranes, or layers, referred to as being in fluid communication are arranged such that a fluid passing through the membrane travels through all the identified components regardless of whether they are physical communication or order of arrangement.

In some embodiments, a coated membrane may be selectively permeable. In some embodiments, the membrane may be a coated reverse osmosis membrane. In some embodiments, the membrane may be a coated water separation membrane. In some embodiments, a coated water permeable- and/or -solute impermeable membrane containing graphene material, e.g., graphene oxide, may provide desired selective gas, liquid, and/or vapor permeability resistance. In some embodiments, the membrane may be a reverse osmosis membrane. In some embodiments, the selectively permeable membrane may comprise multiple layers, where at least one layer contains graphene material.

The term chlorine resistant refers to the osmosis membrane having a substantially similar or reduced membrane activity loss when exposed to chlorine, chloramine or hyperchlorides in the fluid medium.

In some embodiments, the membrane construct can comprise a membrane having a surface for fluid communication with a chlorine solution. In some embodiments, the membrane can comprise a polyamide. In some embodiments, the membrane can be a reverse osmosis membrane. In some embodiments, the membrane can comprise a layer comprising a polyamide, the layer interposed between a reverse osmosis membrane functional layer and the chlorine environment. Suitable reverse osmosis membranes include those described in U.S. Pat. Nos. 4,765,897 and 7,001,518.

In some embodiments, a protective coating can be disposed upon the reverse osmosis membrane surface for fluid communication with a chlorine solution. In some embodiments the coating can comprise graphene oxide and a copolymer crosslinker. In some embodiments, the reverse osmosis membrane can comprise polyamide.

In some embodiments, the reverse osmosis membrane can have a surface for fluid communication or contact with a chlorine solution. In some embodiments the protective coating reverse osmosis membrane and the layer can comprise an optionally substituted graphene oxide material and any or all of the crosslinker units described herein can be in fluid communication. In some embodiments, the layer comprising an optionally substituted graphene oxide material and a crosslinker can be disposed on the surface of the reverse osmosis membrane. In some embodiments, the fluid passing through the membrane travels through all the components regardless of whether they are in physical communication or order of arrangement.

In some embodiments, the protective coating comprises graphene material. In some embodiments, the graphene material can be an optionally substituted graphene oxide. In some embodiments, the optionally substituted graphene oxide may be arranged amongst the crosslinker material in such a manner as to create an exfoliated nanocomposite, an intercalated nanocomposite, or a phase-separated microcomposite. A phase-separated microcomposite phase may be when, although mixed, the optionally substituted graphene oxide exists as separate and distinct phases apart from the crosslinker. An intercalated nanocomposite may be when the crosslinker compounds begin to intermingle amongst or between the graphene platelets but the graphene material may not be distributed throughout the crosslinker. In an exfoliated nanocomposite phase, the individual graphene platelets may be distributed within or throughout the crosslinker. An exfoliated nanocomposite phase may be achieved by chemically exfoliating the graphene material by a modified Hummer's method, a process well known to persons of ordinary skill. In some embodiments, the majority of the graphene material may be staggered to create an exfoliated nanocomposite as a dominant material phase.

In some embodiments, the optionally substituted graphene oxide may be in the form of sheets, planes or flakes. In some embodiments, the graphene material may have a surface area of between about 100 m²/gm to about 5000 m²/gm. In some embodiments, the graphene material may have a surface area of about 100-200 m²/gm, about 200-300 m²/gm, about 300-400 m²/gm, about 400-500 m²/gm, about 500-600 m²/gm, about 600-700 m²/gm, about 700-800 m²/gm, about 800-900 m²/gm, about 900-1000 m²/gm, about 1000-2000 m²/gm, about 2000-3000 m²/gm, about 3000-4000 m²/gm, or about 4000-5000 m²/gm, or any surface area in a range bounded by these surface areas.

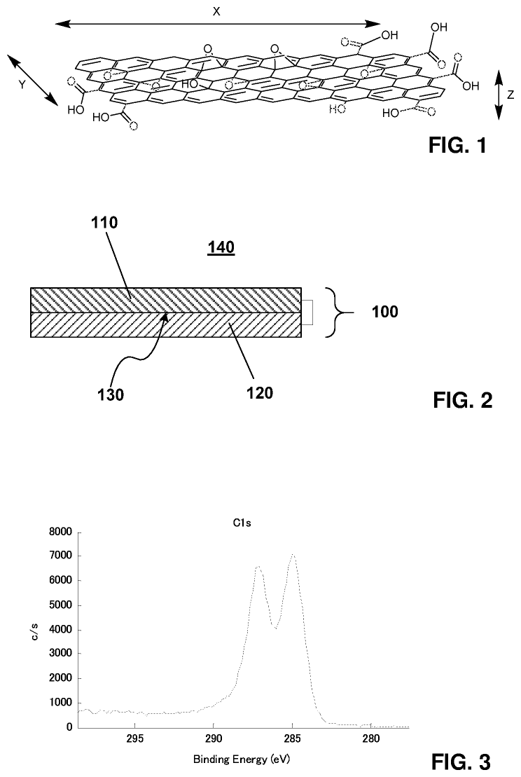

In some embodiments, the graphene oxide may be platelets having one or more dimensions in the nanometer to micron range. In some embodiments, as shown in FIG. 1, the platelets may have dimensions in the x, y and/or z dimension. For example, the platelets may have: an average x dimension between about 0.05 μm to about 50 μm, about 0.05-0.1 μm, about 0.1-0.2 μm, about 0.2-0.3 μm, about 0.3-0.4 μm, about 0.4-0.5 μm, about 0.5-0.6 μm, about 0.6-0.7 μm, about 0.7-0.8 μm, about 0.8-0.9 μm, about 0.9-1 μm, about 1-2 μm, about 2-5 μm, about 5-10 μm, about 10-20 μm, about 20-30 μm, about 30-40 μm, about 40-50 μm or any value in a range bounded by any of these lengths; an average y dimension of about 0.05 μm to about 50 μm, about 0.05-0.1 μm, about 0.1-0.2 μm, about 0.2-0.3 μm, about 0.3-0.4 μm, about 0.4-0.5 μm, about 0.5-0.6 μm, about 0.6-0.7 μm, about 0.7-0.8 μm, about 0.8-0.9 μm, about 0.9-1 μm, about 1-2 μm, about 2-5 μm, about 5-10 μm, about 10-20 μm, about 20-30 μm, about 30-40 μm, about 40-50 μm or any value in a range bounded by any of these lengths. In some embodiments, the graphene oxide comprises GO platelets, the platelets defining an average size of about 0.05 μm to about 50 μm, about 0.05-0.1 μm, about 0.1-0.2 μm, about 0.2-0.3 μm, about 0.3-0.4 μm, about 0.4-0.5 μm, about 0.5-0.6 μm, about 0.6-0.7 μm, about 0.7-0.8 μm, about 0.8-0.9 μm, about 0.9-1 μm, about 1-2 μm, about 2-5 μm, about 5-10 μm, about 10-20 μm, about 20-30 μm, about 30-40 μm, about 40-50 μm or any value in a range bounded by any of these lengths.

In some embodiments, the optionally substituted graphene oxide may be unsubstituted. In some embodiments, the optionally substituted graphene oxide may comprise a non-functionalized graphene base. In some embodiments, the graphene material may comprise a functionalized graphene base, e.g., United States Patent Application Publication No. 20160272575, (Ser. No. 15/073,323, filed Mar. 17, 2016).

Graphene oxide includes any graphene having hydroxyl substituents and saturated carbon atoms. In some embodiments, the modified graphene may comprise a functionalized graphene base. In some embodiments, more than about 90%, about 80-90%, about 70-80%, about 60-70% about 50-60%, about 40-50%, about 30-40%, about 20-30%, or about 10-20%, or any other percentage in a range bounded by these values, of the optionally substituted graphene oxide may be functionalized. In other embodiments, the majority of optionally substituted graphene oxide may be functionalized. In still other embodiments, substantially all the optionally substituted graphene oxide may be functionalized. In some embodiments, the functionalized graphene oxide may comprise a graphene base and functional compound. In some embodiments, a graphene base may be “functionalized,” becoming functionalized graphene when there is one or more types of functional groups present. In some embodiments, the graphene base may be functionalized inherently as a result of synthesis reactions, such as in graphene oxide where epoxide-based functional groups are formed. In some embodiments, the graphene base may be selected from reduced graphene oxide and/or graphene oxide. In some embodiments, the graphene oxide can be graphene oxide, reduced-graphene oxide, functionalized graphene oxide, functionalized reduced-graphene oxide or combinations thereof. In some embodiments, the graphene base may be reduced graphene oxide. The structure below is an example of what a structure of a reduced graphene oxide molecule could look like. However, reduced graphene oxide molecules may have a variety of different structures.

In some embodiments, the graphene base may be graphene oxide. The structure below is an example of what a structure of a graphene oxide molecule could look like. However, graphene oxide molecules may have a variety of different structures.

In some embodiments, the graphene base may be graphene. The structure below is an example of what a structure of a graphene molecule could look like. However, graphene molecules may have a variety of different structures.

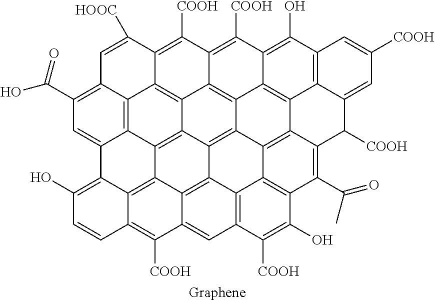 [SMILES: CC(=O)c1c2c3c4c5c(cc(C(=O)O)cc5c(O)c5c(C(=O)O)c6c(C(=O)O)c7c(C(=O)O)cc8c(C(=O)O)cc9c%10c(O)ccc%11c(C(=O)O)c%12cc%13c(C(=O)O)c(O)c1c1c%13c%13c%12c(c%11%10)c%10c9c8c7c7c6c(c54)c(c31)c%13c7%10)C2C(=O)O]

In some embodiments, the graphene material has heteroatom-containing functional groups other than hydroxyl. In other embodiments, only one type of functional group can be present. In some embodiments, a graphene oxide compound comprises one or more hydroxyl groups.

In some embodiments, the mass percentage of the graphene oxide base relative to the total composition of the graphene oxide containing layer can be between about 1 wt % and about 95 wt %. In some embodiments, the mass percentage of the graphene base relative to the total composition of the graphene material containing layer can be about 1-2 wt %, about 2-5 wt %, about 5-10 wt %, about 10-20 wt %, about 20-30 wt %, about 30-40 wt %, 40-50 wt %, about 50-60 wt %, about 60-70 wt %, about 70-80 wt %, about 80-90 wt %, or about 90-95 wt %.

In some embodiments, the membrane coating can comprise crosslinked, optionally substituted graphene oxide. In some embodiments, the crosslinked, optionally substituted graphene oxide comprises a crosslinker covalently bonding adjacent optionally substituted graphene oxides. In some embodiments, the crosslinker can be an ester bond formed from the crosslinking dehydration reactions. In some embodiments, the optionally substituted graphene material may be a crosslinked graphene, where the graphene material may be crosslinked with at least one other graphene base by a crosslinker material/bridge. While not wanting to be limited by theory, it is believed that crosslinking the graphene material may enhance the membrane's mechanical strength and water permeable properties by creating strong chemical bonding and wide channels between graphene platelets to allow water to pass through the platelets easily. In some embodiments, the graphene material may comprise crosslinked graphene material where at the graphene bases are crosslinked such that at least about 1%, about 1-3%, about 3-5%, about 5-10%, about 10-20%, about 20-30%, about 30-40% about 40-50%, about 50-60%, about 60-70%, about 70-80%, about 80-90%, about 90-95%, or all of the graphene material may be crosslinked. The amount of crosslinking may be estimated by the wt % of the crosslinker as compared with the total amount of graphene material present. In some embodiments, one or more of the graphene base(s) that are crosslinked may also be functionalized. In some embodiments, the graphene material may comprise both crosslinked graphene and non-crosslinked graphene; and crosslinked, functionalized graphene and non-crosslinked, functionalized graphene.

In some embodiments, the adjacent optionally substituted graphene oxide can be covalently bonded to each other by one or more crosslinks. In some embodiments, the crosslinks can be a product of a crosslinker. In some embodiments, the crosslinker can comprise the group:

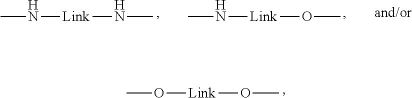

wherein Link can be the body of the crosslinker. In some embodiments, the resulting linkage can be represented as:

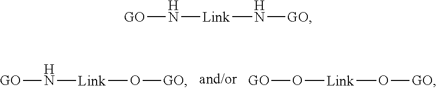

wherein GO represents an optionally substituted graphene oxide and Link can be the body of the crosslinker.

In some embodiments, the crosslink (“Link” or “L”) can be made by a crosslinker to create a covalent linkage that links two or more optionally substituted graphene oxides. In some embodiments, the covalent linkage can be created by an esterification reaction between the copolymer linker molecule and the hydroxyl and/or carbonyl group[s] of the graphene material.

In some embodiments, the graphene oxide can be cross linked with a copolymer crosslinker. In some embodiments, the copolymer crosslinker can comprise at least an optionally substituted vinyl imidazolyl constituent unit and an optionally substituted acrylic amide constituent unit. In some embodiments, the copolymer crosslinker can further comprise an optionally substituted acrylic acid constituent unit. In some embodiments, at least one of the constituent units can be sulfonated. In some embodiments, the copolymer crosslinker can further comprise an optionally substituted acrylate constituent unit. In some embodiments, the copolymer crosslinker can further comprise an optionally substituted methacrylate constituent unit. In some embodiments, the sulfonated functional group is at a terminal end of the side chain. In some embodiments, the optionally substituted vinyl imidazole can comprise a sulfonated vinyl imidazole. In some embodiments, the acrylic amide can comprise a sulfonated acrylic amide. In some embodiments, the copolymer crosslinker comprises 2, 3, 4, 5, 6, or more individual constituent units.

In some embodiments the copolymer has a constituent unit that is an optionally substituted vinyl imidazolyl, e.g. bearing an optionally substituted imidazole side chain.

One example of such vinyl imidazolyl constituent unit is represented by the following formula:

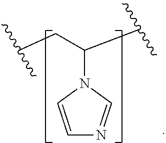

In some embodiments, the vinyl imidazole is further substituted. For example, the imidazole side chain may be further functionalized with a hydrocarbylsulfonate group creating an ionic structure, such as in the following formula:

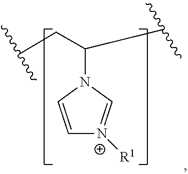

wherein R¹ is a C₁₋₄ hydrocarbylsulfate, such as:

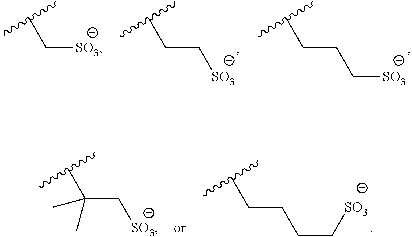

Some copolymers have an optionally substituted acrylic amide constituent unit. For example, some optionally substituted acrylic amide constituent units may be represented by the following formula:

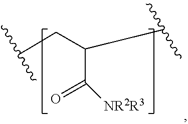

wherein R² and R³ are independently H, optionally substituted C₁₋₈ hydrocarbyl, C₁₋₈ sulfonated hydrocarbylammoniohydrocarbyl, or optionally substituted C₁₋₈ sulfonated hydrocarbyl. In some embodiments, the acrylic amide is substituted with a hydrocarbylsulfate group.

In some embodiments, the acrylic amid, or acrylamide, constituent unit is further functionalized with a hydrocarbylsulfonate side chain creating an ionic structure.

In some embodiments, the C₁₋₈ sulfonated hydrocarbylammoniumhydrocarbyl, e.g. of R² or R³, may be represented by the following formula:

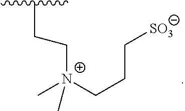

In some embodiments, the hydrocarbylsulfate group may be the following formula:

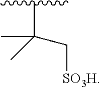 [SMILES: *C(C)(C)CS(=O)(=O)O]

In some embodiments, R² and R³ can be H,

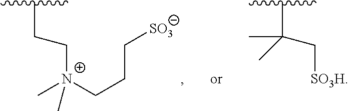

Some copolymers may further include an optionally substituted acrylic acid, acrylate, and or methacrylate constituent unit. In some embodiments, the copolymer may include a constituent unit represented by the following formula:

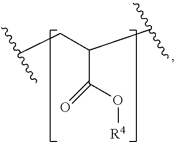

wherein R⁴ may be H, optionally substituted C₁₋₈ hydrocarbyl-OH, C₁₋₈ sulfonated hydrocarbylammoniumhydrocarbyl, or optionally substituted C₁₋₈ sulfonated hydrocarbyl. In some embodiments, R⁴ is —CH₂CH₂OH. In some embodiments, R⁴ is —CH₂CH₂CH₂OH. In some embodiments, R⁴ is —CH₂CH₂CH₂CH₂H. In some embodiments, R⁴ is

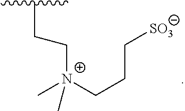

In some examples, the copolymer crosslinker contains an optionally substituted methacrylic acid or methacrylate constituent unit, such as in the following formula:

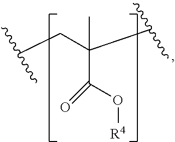

wherein R⁴ may be H, optionally substituted C₁₋₈ hydrocarbyl-OH, C₁₋₈ sulfonated hydrocarbylammoniumhydrocarbyl, or optionally substituted C₁₋₈ sulfonated hydrocarbyl.

In some embodiments, R⁴ is —CH₂CH₂OH.

In some embodiments, R⁴ is —CH₂CH₂CH₂OH.

In some embodiments, R⁴ is —CH₂CH₂CH₂CH₂OH.

In some embodiments, R⁴ is

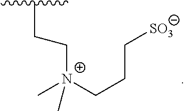

These embodiments may improve the energy efficiency of the reverse osmosis membranes and improve water recover/separation efficiency.

In some embodiments, the polymer crosslinker can comprise an optionally substituted vinyl imidazole constituent unit, an optionally substituted acrylic amide constituent unit, an optionally substituted sulfated acrylic amide constituent unit, and an optionally substituted acrylic acid constituent unit. In some embodiments, the sulfonated acrylic amide can be

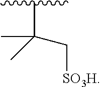 [SMILES: *C(C)(C)CS(=O)(=O)O]

In some embodiments the copolymer crosslinker can be of the formula:

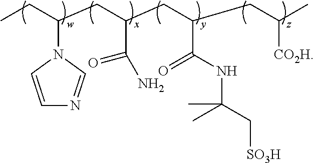

This formula is intended only to represent the constituent units present, and their relative amounts, and not necessarily the order in which they appear, or to imply that the constituent units are present in blocks.

In some embodiments, the sulfonated acrylic amide can be

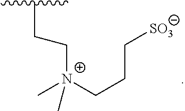

In some embodiments, the copolymer crosslinker comprises the following formula:

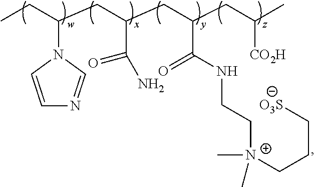

wherein w, x, and/or y are at least 2 and z is at least 1. In some embodiments, w, x, and/or y are greater than z. This formula is intended only to represent the constituent units present, and their relative amounts, and not necessarily the order in which they appear, or to imply that the constituent units are present in blocks.

In some embodiments, the polymer crosslinker can comprise an optionally substituted vinyl imidazole constituent unit, an optionally substituted acrylic amide constituent unit, and an optionally substituted sulfated acrylic amide constituent unit. In some embodiments, the sulfonated acrylic amide can be

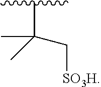 [SMILES: *C(C)(C)CS(=O)(=O)O]

In some embodiments, the copolymer crosslinker comprises the following formula:

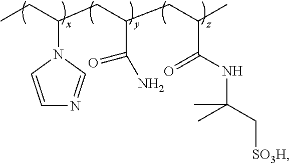

wherein x, y, and/or z are at least 1. This formula is intended only to represent the constituent units present, and their relative amounts, and not necessarily the order in which they appear, or to imply that the constituent units are present in blocks.

In some embodiments, the polymer crosslinker can comprise an optionally substituted vinyl imidazole constituent unit, an optionally substituted acrylic amide constituent unit, and an optionally substituted acrylic acid constituent unit. In some embodiments, the copolymer crosslinker comprises the following formula:

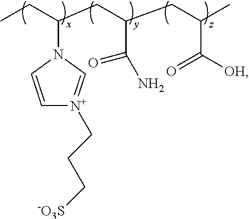

wherein x, y, and z are at least 1. This formula is intended only to represent the constituent units present, and their relative amounts, and not necessarily the order in which they appear, or to imply that the constituent units are present in blocks.

In some embodiments, the polymer crosslinker can comprise an optionally substituted vinyl imidazole constituent unit, an optionally substituted acrylic amide constituent unit, an optionally substituted sulfated acrylic amide constituent unit, and an optionally substituted acrylate constituent unit. In some embodiments, the copolymer crosslinker comprises the following formula:

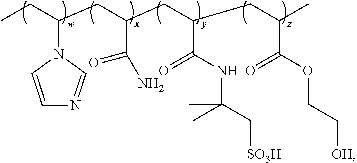

wherein w, x and/or z are at least 2 and y is at least 1. In some embodiments, w, x and/or z are greater than y. This formula is intended only to represent the constituent units present, and their relative amounts, and not necessarily the order in which they appear, or to imply that the constituent units are present in blocks.

In some embodiments, the polymer crosslinker can comprise an optionally substituted vinyl imidazole constituent unit, an optionally substituted acrylic amide constituent unit, an optionally substituted sulfated methacrylate constituent unit, and an optionally substituted acrylate constituent unit. In some embodiments, the sulfated methacrylate constituent unit comprise

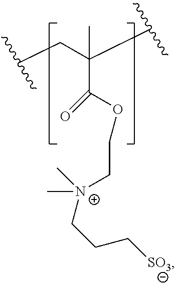

In some embodiments, the copolymer crosslinker comprises:

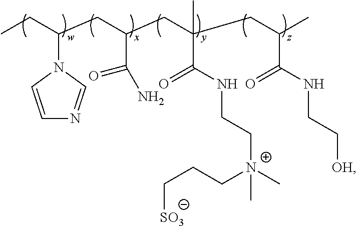

wherein w, x and/or z are at least 2 and y is at least 1. In some embodiments, w, x and/or z are greater than y. This formula is intended only to represent the constituent units present, and their relative amounts, and not necessarily the order in which they appear, or to imply that the constituent units are present in blocks.

In some embodiments, the order of the constituent units may be randomized. In some embodiments, the copolymer constituent units can be alternating copolymers, periodic copolymers, statistical copolymers and/or block copolymers. It is believed that substituting a carboxyl acid and/or a sulfonic acid on the crosslinker may increase the hydrophilicity of the membrane, thereby increasing the total water flux.

In some embodiments, the resulting linkage can be created by a substitution reaction, wherein a hydroxyl functional group of the optionally substituted graphene oxide can be linked. While not wanting to be limited by theory, linking at the hydroxyl group location and may result in a carbon becoming covalently bonded via an ester linkage or an ether linkage.

In some embodiments, the weight ratio of optionally substituted graphene oxide to optionally substituted crosslinker can be from about 10:1 to about 1:100. In some embodiments, the weight ratio of optionally substituted graphene oxide to optionally substituted crosslinker can be from about 10:1 (e.g. 10 mg GO and 1 mg crosslinker) to about 5:1, about 10:1 to about 9:1, about 9:1 to about 8:1, about 8:1 to about 7:1, about 7:1 to about 6:1, about 6:1 to about 5:1, about 5:1 to about 4:1, about 4:1 to about 3:1, about 3:1 to about 2:1, about 2:1 to about 1:1, about 1:1 to about 1:2, about 1:2 to about 1:3, about 1:3 to about 1:4, about 1:4 to about 1:5, about 1:5 to about 1:6, about 1:6 to about 1:7, about 1:7 to about 1:8, about 1:8 to about 1:9, about 1:9 to about 1:10, about 5:1 to about 2:1, about 2:1 to about 1:1, about 1:1 to about 1:2, about 1:2 to about 1:5, about 1:5 to about 1:10, about 1:10 to about 1:25, about 1:25 to about 1:50, or about 1:50 to about 1:100, or any ratio in a range bounded by any of these values. In some embodiments, the weight ratio of graphene oxide to crosslinker in the composite can be a value ranging from 1-90 wt %.

In some embodiments, the crosslinker can crosslink a first interior carbon atom on a face of a first optionally substituted graphene oxide platelet to a second interior carbon atom on a face of a second optionally substituted graphene oxide platelet. An interior carbon atom on a face of an optionally substituted graphene oxide platelet is a carbon atom that is not on an outer border of the optionally substituted graphene oxide platelet. For example, for the graphene oxide platelet depicted below, the interior carbon atoms are shown in bold. It should be noted that the structure below is depicted only to illustrate the principle of an interior carbon atom, and does not limit the structure of graphene oxide.

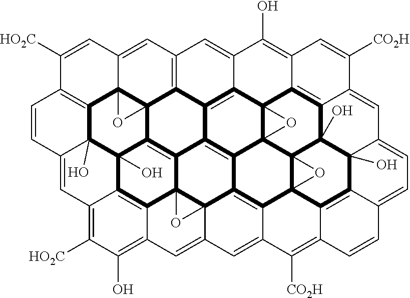

In some embodiments, an optionally substituted graphene oxide crosslinked with crosslinker, can be at least 5 atom %, about 5-7 atom %, about 7-10 atom %, about 10-12 atom %, about 12-14 atom %, about 14-16 atom %, about 16-18 atom %, about 18-20 atom %, about 20-22 atom %, about 22-24 atom %, about 24-26 atom %, about 26-28 atom %, about 28-30 atom %, about 30-32 atom %, about 32-34 atom %, about 34-36 atom %, about 36-38 atom %, about 38-40 atom %, about 20-25 atom %, about 25-30 atom %, about 30-40 atom %, or about 40-50 atom % oxygen, or any value in a range bounded by any of these values. These atom percentages could be before or after soaking. The atom percentage of oxygen can be determined by x-ray photoelectron spectroscopy (XPS).

In some embodiments, an optionally substituted graphene oxide, crosslinked with crosslinker, can be about 20-90 atom % carbon. The optionally substituted graphene oxide, crosslinked with crosslinker, can be about 20-30 atom %, about 30-40 atom %, about 40-50 atom %, about 50-60 atom %, about 60-70 atom %, about 65-70 atom %, about 70-75 atom %, about 75-80 atom %, about 50-55 atom %, about 55-60 atom %, about 60-62 atom %, about 62-64 atom %, about 64-66 atom %, about 66-68 atom %, about 68-70 atom %, about 70-72 atom %, about 72-74 atom %, about 74-76 atom %, about 76-80 atom % carbon, or any atom % carbon in a range bounded by any of these percentages. These atom percentages could be before or after soaking. The atom percentage of carbon can be determined by XPS.

In some embodiments, an optionally substituted graphene oxide crosslinked with crosslinker, can have a carbon to oxygen atom ratio (carbon atoms/oxygen atoms) of about 1-5.5, about 1.0-1.5, about 1.5-2.0, about 1.7-3.5, about 2.0-2.5, about 2.5-3.0, about 1.8-3.3, about 3.0-3.5, about 1-1.2, about 1.2-1.4, about 1.4-1.6, about 1.6-1.8, about 1.8-2, about 2-2.2, about 2.2-2.4, about 2.4-2.6, about 2.6-2.8, about 2.8-3, or any ratio in a range bounded by any of these values. These ratios could be before or after soaking.

In some embodiments, an optionally substituted graphene oxide crosslinked with crosslinker, can contain nitrogen in an amount that is less than about 20 atom %, about 1-1.4 atom %, about 1.4-1.6 atom %, about 1.6-1.8 atom %, about 1.8-2 atom %, about 2-2.2 atom %, about 2.2-2.4 atom %, about 2.4-2.6 atom %, about 2.6-2.8 atom %, about 2.8-3 atom %, or any percentage of nitrogen atoms in a range bounded by any of these values. These atom percentages could be before or after soaking. The percentage of nitrogen atoms can be determined by XPS.

In some embodiments, an optionally substituted graphene oxide crosslinked with crosslinker, can have an interlayer distance, or d-spacing that can be between about 0.5-3 nm, about 0.5-0.6 nm, about 0.6-0.7 nm, about 0.7-0.8 nm, about 0.8-0.9 nm, about 0.9-1.0 nm, about 1.0-1.1 nm, about 1.1-1.2 nm, about 1.2-1.3 nm, about 1.3-1.4 nm, about 1.4-1.5 nm, about 1.5-1.6 nm, about 1.6-1.7 nm, about 1.7-1.8 nm, about 1.8-1.9 nm, about 1.9-2.0 nm, about 2.0-2.1 nm, about 2.1-2.2 nm, about 2.2-2.3 nm, about 2.3-2.4 nm, about 2.4-2.5 nm, about 2.5-2.6 nm, about 2.6-2.7 nm, about 2.7-2.8 nm, about 2.8-2.9 nm, or about 2.9-3.0 nm, or any distance in a range bounded by any of these values. The d-spacing can be determined by x-ray powder diffraction (XRD).

In some embodiments, the membrane can also comprise a substrate. In some embodiments, the substrate may comprise a porous material. In some embodiments, the crosslinked graphene material and crosslinker are disposed upon the substrate. In some embodiments, the membrane can further comprise a porous substrate, wherein the crosslinked graphene material and crosslinker form a layer disposed upon the substrate. In some embodiments, the porous material may be a polymer. In some embodiments, the polymer may be polyethylene, polypropylene, polysulfone, polyether sulfone, polyvinylidene fluoride, polyamide, polyimide, and/or mixtures thereof. In some embodiments, the polymer may be polysulfone. In some embodiments, the porous material may comprise a polysulfone based ultrafiltration membrane. In some embodiments, the porous material may comprise hollow fibers. The hollow fibers may be cast or extruded. The hollow fibers may be made, for example, as described in U.S. Pat. Nos. 4,900,626; 6,805,730; and United States Patent Application Publication No. 2015/0165389, which are incorporated by reference in their entireties.

Some examples of a coated membrane structure comprising a polymeric constituent unit, e.g., vinyl imidazole constituent unit, an acrylic amide constituent unit, a sulfated acrylic amide constituent unit, a methacrylic acid constituent unit, and/or an acrylic acid constituent unit, etc., may be represented by membrane 100 in FIG. 2. In some embodiments, the membrane, 100, can comprise can comprise a protective coating 110 and a membrane element 120. In some embodiments, as shown in FIG. 2, the membrane may comprise a protective coating, 110, where the protective coating can protect the components of the membrane 100 from chlorinated environments and/or solutions. In some embodiments, the protective coating 110 can comprise graphene oxide cross linked with the aforementioned copolymer constituent units. In some embodiments, the coating 110 may be disposed on the surface 130 of the membrane element 120. The surface 130 can be on the surface exposed to or in fluid communication with the solution 140 containing chlorine, hypochlorites, or other chlorine oxides. In some embodiments, the membrane element 120 comprises any of the previously described copolymers. In some embodiments, the membrane element can comprise a separate salt rejection layer of a membrane construct. In some embodiments, the membrane element 120 may not contain polyamide. In some embodiments, the membrane selectively passes water there through while retaining the passage of gas, solute, or liquid material from passing there through. In some embodiments, as a result of the layers, the membrane may provide a durable desalination system that can be selectively permeable to water, and less permeable to salts. In some embodiments, as a result of the layers, the membrane may provide a durable reverse osmosis system that may effectively filter or desalinate saline/polluted water or feed fluids. In some embodiments, the coated membrane can provide any or all of the aforedescribed. In some embodiments, the coated membrane can provide substantially similar flux and/or salt rejection while or after contacting a chlorine solution.

In some embodiments, the protective coating can comprise additives. In some embodiments, the composite coating may further comprise an additive mixture. In some embodiments, the additives and/or additive mixture can comprise a borate salt, tetraethyl orthosilicate, an optionally substituted aminoalkylsilane, silica nanoparticles, polyethylene glycol, trimesic acid, 2,5-dihydroxyterephthalic acid, CaCl₂, and/or a combination thereof. In some embodiments, the borate salt can comprise K₂B₄O₇, Li₂B₄O₇, Na₂B₄O₇, and/or a combination thereof. In some embodiments, the borate salt can be about 0.001 wt % to about 20 wt % of the composite.

In some embodiments, the composite coating can further comprise an additive mixture. In some embodiments, the additive mixture can comprise a borate salt, tetraethyl orthosilicate, an optionally substituted aminoalkylsilane, silica nanoparticles, polyethylene glycol, trimesic acid, 2,5-dihydroxyterephthalic acid, CaCl₂, and/or a combination thereof. In some embodiments, the borate salt can comprise K₂B₄O, Li₂B₄O₇, Na₂B₄O₇, or a combination thereof. In some embodiments, the borate salt can be 0.001 wt % to about 20 wt % of the composite. In some embodiments, the composite can further comprise an acid additive. In some embodiments, the acid additive can comprise HCl, H₂SO₄, camphor sulfuric acid or a combination thereof. In some embodiments, the acid additive can be 0.001 wt % to 10 wt % of composite. In some embodiments, the composite can further comprise a biopolymer. In some embodiments, the biopolymer can comprise sericin.

In some embodiments, the protective coating and/or precursor mixture thereof can comprise acid additives. In some embodiments, the composite coating may further comprise an acid additive mixture. In some embodiments, the acid additives and/or acid additive mixture can comprise an acid. In some embodiments, the acid additive can be hydrochloric acid (HCl), sulfuric acid (H₂SO₄), and/or camphor sulfuric acid. In some embodiments, the acid added can be about 0.001 to 10 wt %, about 0.001-0.005 wt %, about 0.005-0.01 wt %, about 0.01-0.05 wt %, about 0.05-0.1 wt %, about 0.1-0.5 wt %, about 0.5-1.0 wt %, about 1.0-2.0 wt %, about 2.0-3.0 wt %, about 3.0-4.0 wt %, about 4-5 wt %, about 5-6 wt %, about 6-7 wt %, about 7-8 wt %, about 8-9 wt %, about 9-10 wt %, or any combination or permutation of the aforementioned values.

In some embodiments, the protective coating may comprise a biopolymer. In some embodiments, the biopolymer can comprise sericin. Sericin fibers may comprise three layers, all with fibers running in different patterns of directionality. The innermost layer, typically is composed of longitudinally running fibers, the middle layer is composed of cross fiber directional patterned fibers, and the outer layer comprises fiber directional fibers. The overall structure can also vary based on temperature, whereas the lower the temperature, there were typically more β-sheet conformations than random amorphous coils. In some embodiments, the sericin can be Sericin A, which can be insoluble in water, can be the outermost layer, and/or can contain approximately 17% nitrogen, along with amino acids such as serine, threonine, aspartic acid, and glycine. In some embodiments, the sericin can be Sericin B, composed the middle layer and is nearly the same as sericin A, but also contains tryptophan. In some embodiments, the sericin can be Sericin C. In some embodiments, Sericin C can be the innermost layer, the layer that comes closest to and is adjacent to fibroin. Also insoluble in water, Sericin C can be separated from the fibroin via the addition of a hot, weak acid. Sericin C may also contain the amino acids present in B, along with the addition of proline. In some embodiments, the sericin can be water soluble.

In some embodiments, the coated membrane can provide a flux of about greater than at least 2.5 gallons per square feet per day (GFD); 2.5-3.0 GFD, 3.0-3.5 GFD, 3.5-4.0 GFD, 4.0-4.5 GFD, 4.5-5.0 GFD, or at least 5.0 GFD or any flux in a range bounded by any of these flux rates. In some embodiments the coated membrane can provide a resistance to chlorine deterioration. In some embodiments, the coated membrane can maintain at least 75%, 75-80%, 80-85%, 85-90%, 90-95% or at least 95% of the original flux rate over a period of time, e.g., at least 100 hours, 100-200 hours, 200-300 hours, 300-400 hours, 400-500 hours, 500-600 hours, 600-700 hours, 700-800 hours, 800-900 hours, 900-1000 hours, 1000-1200 hours, 12-00-1400 hours, 1400-1600 hours, 1600-1800 hours, 1800-2000 hours, 2000-4000 hours, 4000-6000 hours, 6000-8000 hours, 8000-10000 hours, or at least 10,000 hours, or any time period in a range bounded by any of these time periods.

In some embodiments, the coated membrane can maintain at least 75%, 75-80%, 80-85%, 85-90%, 90-95% or at least 95% of the original flux rate over an amount of C exposure, e.g., at least 100 ppm·h, 100-200 ppm·h, 200-300 ppm·h, 300-400 ppm·h, 400-500 ppm·h, 500-600 ppm·h, 600-700 ppm·h, 700-800 ppm·h, 800-900 ppm·h, 900-1000 ppm·h, 1000-1200 ppm·h, 12-00-1400 ppm·h, 1400-1600 ppm·h, 1600-1800 ppm·h, 1800-2000 ppm·h, 2000-4000 ppm·h, 4000-6000 ppm·h, 6000-8000 ppm·h, 8000-10000 ppm·h, or at least 10,000 ppm·h, or any time period in a range bounded by any of these time periods.

In some embodiments, the coated membrane can prevent fouling. In some embodiments, the reduction of fouling can be expressed as a maintenance of membrane flux over time. One suitable method for determining the extent of antifouling can be by a cross-flow membrane cell similar to that described in United States Patent Publication 2009/0188861, the teachings of which are incorporated herein by reference. One suitable cross-flow membrane cell is commercially available from GE Osmonics SEPA CF-II and held in a GE Osomnics cell holder. The cross-flow membrane cell can be similar to that shown in United States Patent Publication 2009/0188861. The feed pump shown therein may be provided for supplying feed water to the cell. The feed water pump can be a 3-piston Wanner Hydracell pump controlled by a Leeson Speedmaster variable speed drive, which controls the cross-flow velocity of the flow through the membrane 100. Feed and permeate flow, pressure, conductivity and temperature could be monitored continuously using a data acquisition system (National Instruments LabView). The feed water temperature could be kept constant at 25° C., using a circulator (Thermo Neslab RTE-7). Feed and permeate flow, pressure, conductivity and temperature could be monitored continuously using a data acquisition system (National Instruments LabView). A reverse osmosis copolymer coated polyamide thin-film composite membrane comprised of the materials described herein could be used as described herein. The feed channel spacer could be about 34 mil.

In the GE Osmonics SEPA CF-II cross-flow membrane cell as described in United States Patent Publication 2009/0188861, a single piece of rectangular membrane can be installed in the cell body bottom shown on top of the feed spacer and shim (optional). Guideposts shown can provide proper alignment of the membrane. The permeate carrier can be placed into the cell body top, which fits over the guideposts. Guidepost location can provide proper orientation of the cell body halves. The cell body can be inserted into the cell holder shown, and hydraulic pressure can be applied to the bottom of the holder. This pressure may cause the piston to extend upward and compress the cell body against the cell holder top. Double O-rings in the cell body may provide a leak-proof seal. The feed stream can be pumped from the feed vessel to the feed inlet, which can be located on the cell body bottom. Flow can continue through a manifold into the membrane cavity. Once in the membrane cavity, the feed water may flow tangentially across the membrane surface. Feed water flow can be controlled and may be laminar depending on the feed spacer and the fluid velocity used. A portion of the feed water can permeate the membrane and flow through the permeate carrier, which may be located in the cell body top. The permeate flows to the center of the cell body top, is collected in another manifold, and then flows out through the permeate outlet connection into the permeate collection vessel. The concentrate stream, which contains the material rejected by the membrane, may continue to sweep over the membrane and collect in the manifold. The concentrate may then flow through the concentrate flow control valve into the feed vessel. U.S. Pat. No. 4,846,970 describes such a cross-flow membrane cell, the teachings of which are incorporated herein by reference.

In some embodiments, the membrane construct may comprise a protective coating, 110. In some embodiments, the membrane to be protected may have a surface 130 for fluid communication with a chlorinated or chlorine solution or fluid 140, e.g., water, source. In some embodiments, the protective coating can be disposed on top of the surface for fluid communication with a chlorine solution to protect it from the chlorinated environment. In some embodiments, the protective coating comprises the aforementioned GO crosslinked material, e.g., the graphene oxide could be crosslinked with the copolymer crosslinker, and the copolymer crosslinker could be comprising at least an optionally substituted vinyl imidazolyl constituent unit and an optionally substituted acrylic amide constituent unit.

In some embodiments, the membrane 100 may be disposed between or separate a fluidly communicated first fluid reservoir and a second fluid reservoir. In some embodiments, the first reservoir may contain an unprocessed fluid, e.g., a feed fluid or solution, upstream and/or at the membrane. In some embodiments, the feed fluid or solution may be comprised of chlorine or hyperchlorides. In some embodiments, the second reservoir may contain a processed fluid downstream and/or at the membrane. In some embodiments, the membrane can allow passing of the desired water there through while retaining the solute or contaminant fluid material. In some embodiments, the membrane can allow filtering to selectively remove solute and/or suspended contaminants from feed fluid. In some embodiments, the membrane has a desired flow rate. In some embodiments, the membrane has a desired flux rate. In some embodiments, the membrane can maintain the desired flow rate and/or flux rate over a desired period of time, e.g., those parameters described elsewhere herein. In some embodiments, the membrane may comprise ultrafiltration material.

In some embodiments, the mixture can be allowed to rest a sufficient time such that interface polymerization can take place on the surface of the solution before the dipping occurs. In some embodiments, the method comprises resting the mixture at rest at room temperature for about 1 hour to about 6 hours, about 1-2 hours, about 2-3 hours, about 3-4 hours, about 4-5 hours, about 5-6 hours, or about 3 hours, or about any time in a range bounded by any of these time periods. In some embodiments, the method comprises dipping the cured substrate in the mixture for about 15 sec to about 15 min, about 10 sec to about 10 min, about 10-20 sec, about 20-30 sec, about 30-40 sec, about 40-50 sec, about 50 sec to 1 min, about 1-2 min, about 2-3 min, about 3-4 min, about 4-5 min, about 5 min, about 5-6 min, about 6-7 min, about 7-8 min, about 8-9 min, about 9-10 min, about 10 min, about 10-11 min, about 11-12 min, about 12-13 min, about 13-14 min, or about 14-15 min, or about any time period in a range bounded by any of these time periods.

### Application of GO and Crosslinker by a Mixture Coating Method

In some embodiments, applying a graphene oxide aqueous solution and a crosslinker aqueous solution to the substrate can further comprise creating a mixed coating solution and then applying the coating mixture to the membrane. In some embodiments, the method can comprise resting the coating solution to form a coating mixture. In some embodiments, the method can comprise curing the coating solution to polymerize and/or crosslink the coating mixture. In some embodiments, the method can comprise drying the cured and/or applied coating solution to form a coating mixture. In some embodiments, the plurality of layers can range from 1 to about 100, where a single mixed layer defines a single layer.

In some embodiments of the mixture coating method, creating a mixed coating solution comprises creating a single mixed coating solution by mixing aqueous solutions of graphene oxide and crosslinker. In some embodiments, creating a mixed coating solution comprises mixing the graphene oxide solution with a concentration that can range from about 0.001 wt-0.1 wt %, about 0.001-0.003 wt %, about 0.003-0.005 wt %, about 0.005-0.007 wt %, about 0.007-0.01 wt %, about 0.01-0.03 wt %, about 0.03-0.05 wt %, about 0.05-0.1 wt %, about 0.03% wt %, or about 0.1 wt %, or any weight percentage in a range bounded by any of these percentages. In some embodiments, creating the mixed coating solution comprises mixing the crosslinker aqueous solution with a concentration that can range from 0.01-5 wt %, about 0.01-0.05 wt %, about 0.05-0.1 wt %, about 0.1-0.5 wt %, about 0.5-1.0 wt %, about 1-2 wt %, about 2-3 wt %, about 3-4 wt %, about 4-5 wt %, about 1.2 wt %, or about 5 wt % or any weight percentage in a range bounded by any of these percentages. The result of mixing the aqueous graphene oxide solution with the aqueous crosslinker solution a coating mixture.

In some embodiments of the mixture coating method, creating a mixed coating solution comprises adding an additive mixture. In some embodiments, the additives and/or additive mixture can comprise a borate salt, tetraethyl orthosilicate, an optionally substituted aminoalkylsilane, silica nanoparticles, polyethylene glycol, trimesic acid, 2,5-dihydroxyterephthalic acid, CaCl₂, and/or a combination thereof. In some embodiments, the borate salt can comprise K₂B₄O₇, Li₂B₄O₇, Na₂B₄O₇, and/or a combination thereof. In some embodiments, the borate salt can be about 0.001 wt % to about 20 wt % of the composite. In some embodiments the borate salt can be present in the composite in about 0.001-0.005 wt %, about 0.005-0.01 wt %, about 0.01-0.05 wt %, about 0.05-0.1 wt %, about 0.1-0.5 wt %, about 0.5-1.0 wt %, about 1-5 wt %, about 5-10 wt %, about 10-15 wt %, or about 15-20 wt %, or any weight percentage in a range bounded by any of these percentages.

In some embodiments of the mixture coating method, creating a mixed coating solution comprises adding an acid additive to the single mixed coating solution. In some embodiments, the acid additive can be hydrochloric acid (HCl), sulfuric acid (H₂SO₄), camphor sulfuric acid. In some embodiments, the acid added can be about 0.1-5 wt %, of the coating solution, about 0.1-0.5 wt %, about 0.5-1.0 wt %, about 1.0 wt %, about 1-2 wt %, about 2-3 wt %, about 3-4 wt %, about 4-5 wt %, or about 5 wt %, or about any weight percentage in a range bounded by any of these percentages. The result is a coating solution.

In some embodiments of the mixture coating method, the method comprises resting the coating solution at about room temperature for about 30 min to about 12 hours to allow for the graphene oxide and the crosslinker to facilitate pre-reacting. In some embodiments, resting the coating solution can be done for about 1-6 hours, about 5-30 min, about 30 min-1 hour, about 1-2 hours, about 2-4 hours, about 4-6 hours, about 6-8 hours, about 8-10 hours, about 10-12 hours, about 12 hours, or any time period in a range bounded by any of these times. In some embodiments, resting the coating solution can be done for about 3 hours. While not wanting to be limited by theory, it is thought that resting the coating solution allows the graphene oxide and the crosslinker to begin covalently bonding in order to facilitate a final crosslinked layer. The result is a coating mixture.

In some embodiments of the mixture coating method, the mixture coating method then comprises applying the coating mixture to the substrate. In some embodiments, applying a coating mixture to the substrate can be by blade coating, spray coating, dip coating, spin coating, or other methods known by those skilled in the art. In some embodiments, applying a coating mixture can be done by blade coating the substrate.

In some embodiments, the method includes the step of blade casting the graphene oxide crosslinked slurry to produce a coating formed upon the functional membrane layer, for example the polyamide membrane component, having the desired chlorine resistance and/or flux and/or salt rejection characteristics.

In some embodiments, the mixture coating method optionally comprises rinsing the resulting substrate in DI water after application of the coating mixture to remove excess material. The result is a coated substrate

### EXAMPLES

It has been discovered that embodiments of the selectively permeable membranes described herein have improved resistance to chlorine. These benefits are further shown by the following examples, which are intended to be illustrative of the embodiments of the disclosure, but are not intended to limit the scope or underlying principles in any way.

### Example 1.1.1: Synthesis of Graphene Oxide

GO Preparation: GO was prepared from graphite using the modified Hummers method. 2.0 g of Graphite flakes (Sigma Aldrich, St. Louis, Mo., USA, 100 mesh) was oxidized in a mixture of 2.0 g NaNO₃ (Aldrich), 10 g KMnO₄ (Aldrich) and 96 mL of concentrated H₂SO₄ (Aldrich, 98%) at 50° C. for 15 hours; then the resulting paste mixture was poured into 400 g of ice following by adding 30 mL of hydrogen peroxide (Aldrich, 30%). The resulting solution was then stirred for 2 hours to reduce the manganese dioxide, then filtered through filter paper and washed with DI water. The resulting solid was then collected and dispersed in DI water by stirring, then centrifuged at 6300 rpm for 40 min, and the aqueous layer was decanted. The remaining solid was then dispersed in DI water and the washing process was repeated 4 times. The purified GO was then dispersed in DI water under sonication (power of 20 W) for 2.5 hours to prepare the GO dispersion (0.4 wt %), or GC-1.

### Example 1.1.2: Synthesis of Crosslinker Compound #1 (CLC-1 [PAAVA])

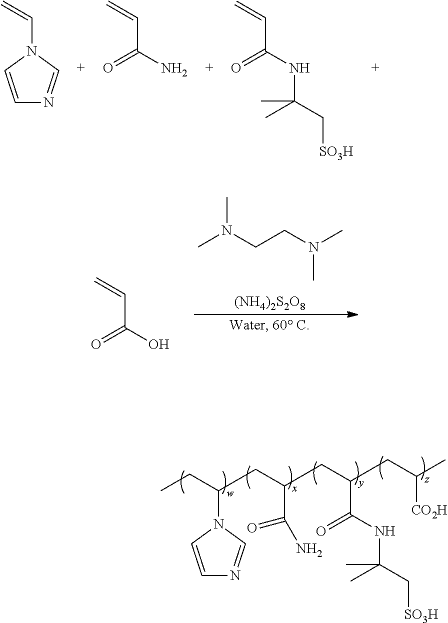

Synthesis of Polymer PAAVA (CLC-1): A water (50 mL) solution of acrylic amide (3.0 g), 2-acrylamido-2-methyl-1-propanesulfonic acid (4.37 g), vinyl imidazole (3.91 g) and acrylic acid (1.5 g), tetramethylethylenediamine (0.1 mL) was degassed for 30 min. Then 0.05 g ammonium persulfate was added to the solution as initiator. The whole was stirred at 60° C. for 16 hours under argon atmosphere. The resulting solution was dropped into ethanol (1500 mL) to form white precipitate. The mixture was stirred overnight, then filtered to collect the solid, which was dried under vacuum to remove solvents. The resulted solid was redissolved in distilled water (50 mL) again. The solution was filtered through 0.45 um membrane filter first, then dropped into ethanol (1800 mL). The mixture was stirred overnight, and the white precipitate was collected by filtration. After dried under vacuum, 6 gram of white solid was obtained in 50% yield. ¹H NMR (D₂O, 400 MHz) δ 8.6-8.8 (bs, 1H), 7.4-7.7 (m, 3H), 4.0-4.5 (m, 2H), 3.0-3.5 (m, 2H), 1.1-2.3 (m, 18H).

### Example 1.1.3: Synthesis of Crosslinker Compound #2 (CLC-2 [PAVAS])

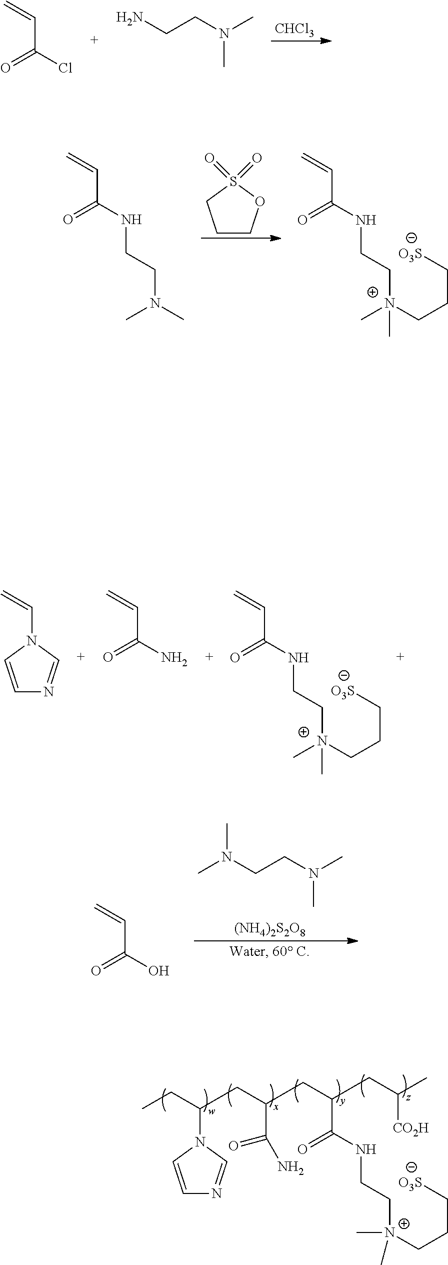

N-(2-(dimethylamino)ethyl)acrylamide: To a solution of N, N-dimethylethylenediamine (13.2 g) in chloroform (150 ml), was added a solution of acryloyl chloride (14.55 mL) in 100 mL chloroform dropwise in one hour duration under argon atmosphere with ice bath cooling. After completion of addition of acryloyl chloride solution, the reaction was stirred for another hour at room temperature. The resulting mixture was washed with NaOH aqueous solution (1M, 200 ml), then washed with brine, dried over MgSO₄ overnight. After filtered solid, the solvent was removed under reduced pressure to give a colorless liquid (6.0 g, in 28% yield). ¹H NMR (D₂O, 400 MHz) δ 6.67 (bs, 1H), 6.16 (m, 2H), 5.60 (dd, 1H), 3.40 (quartet, 2H), 2.42 (t, 2H), 2.23 (s, 6H).

3-((2-acryamidoethyl)dimethylammonium)propane-1-sulfonate: To a solution of N-(2-(dimethylamino)ethyl)acrylamide (6.0 g) in THF (25 mL) was added 1,3-propane-sultone (5.12 g) under argon. The whole was stirred at 35° C. for 2 hours. After cooled to room temperature, a white solid (6.0 g, 60% yield) was collected via filtration, washing with THF and dried under vacuum. ¹H NMR (D₂O, 400 MHz) δ 6.20 (m, 2H), 5.74 (dd, 1H), 3.71 (t, 2H), 3.45 (m, 4H), 3.10 (s, 6H), 2.90 (t, 2H), 2.17 (m, 2H).

Polymer PAVAS (CLC-2): A water solution of vinylimidzole (1.9 g), acrylamide (1.42 g), 3-((2-acrylamidoethyl)dimethylammonium)propane-1-sulfonate (2.64 g), acrylic acid (0.72 g), N,N,N′,N′-tetramethylethylenediamine (0.05 mL) was degassed for 30 min. Then 0.05 g ammonium persulfate was added. The whole was heated at 60° C. for 7 hours while stirring under argon atmosphere. After cooled to room temperature, the solution was dropped into ethanol (1000 mL) while stirring to form white precipitate. The mixture was stirred for 5 hours, then filtered through 0.45 um polypropylene membrane. The solid was collected, dried under vacuum to afford 4 g white solid in 83% yield. ¹H NMR (D₂O, 400 MHz) δ 7.1^{˜}7.6 (bm, 3H), 3.58 (m, 6H), 3.08 (bs, 8H), 2.90 (m, 2H), 1.2^{˜}2.4 (m, 17H).

### Example 1.1.4: Synthesis of Crosslinker Compound #3 (CLC-3) (PAAV)

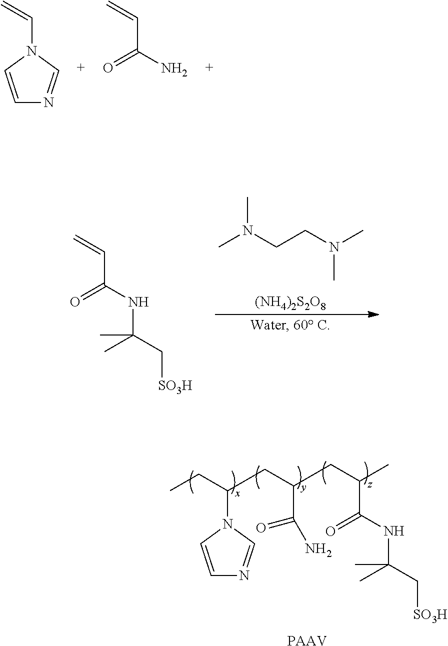

[PAAV] (CLC-3) Preparation: A monomer aqueous solution of acrylic amide (3.0 g), 2-acrylamido-2-methyl-1-propanesulfonic acid (4.37 g), vinyl imidazole (3.97 g), tetramethylethylenediamine (0.1 mL), was prepared and degassed for 30 min. To the solution, ammonium persulfate (0.05 g) was added as initiator. The polymerization was conducted at 60° C. for 8 hours with stirring under argon. The crude polymer was obtained by precipitating the reaction mixture in ethanol. The product was further refined to get pure polymer by repeating dissolving in pure water and precipitating in ethanol. Finally, the obtained polymer was dried under vacuum overnight.

### Example 1.1.5: Synthesis of Crosslinker Compound #4 (CLC-4 PAAVS])

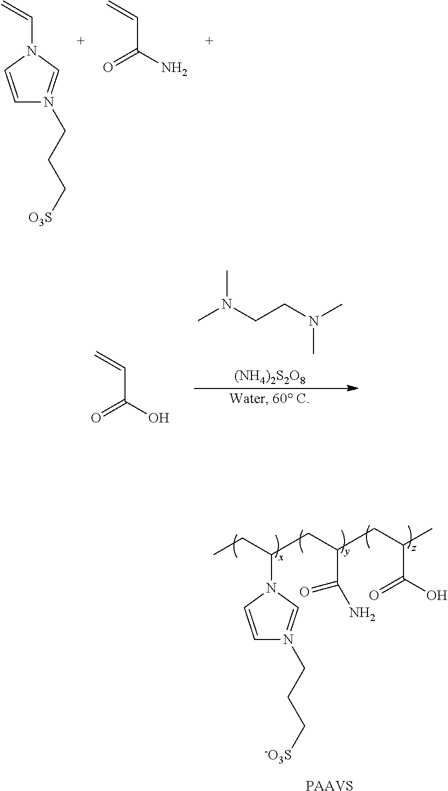

Polymer PAAVS: A water solution of 3-(3-((λ¹-oxidaneyl)dioxo-λ⁶-sulfaneyl)propyl)-1-vinyl-1H-3λ⁴-imidazole (5.0 g), acrylamide (3.0 g), acrylic acid (0.72 g), N,N,N′,N′-tetramethylethylenediamine (0.1 mL) was degassed for 30 min. Then 0.05 g ammonium persulfate was added. The whole was heated at 60° C. for 7 hours while stirring under argon atmosphere. After cooled to room temperature, the solution was dropped into ethanol (1000 mL) while stirring to form white precipitate. The mixture was stirred for 5 hours, then filtered through 0.45 um polypropylene membrane. The solid was collected, dried under vacuum to afford 4 g white solid in 50% yield. ¹H NMR (D₂O, 400 MHz) δ 9.0 (bs, 1H), 7.5 (bs, 2H), 4.3 (m, 2H), 2.8 (m, 2H), 2.3 (m, 2H), 1.4^{˜}2.2 (m, 12H).

### Example 1.1.6: Synthesis of Crosslinker Compound #5 (CLC-5 [PAVAL])

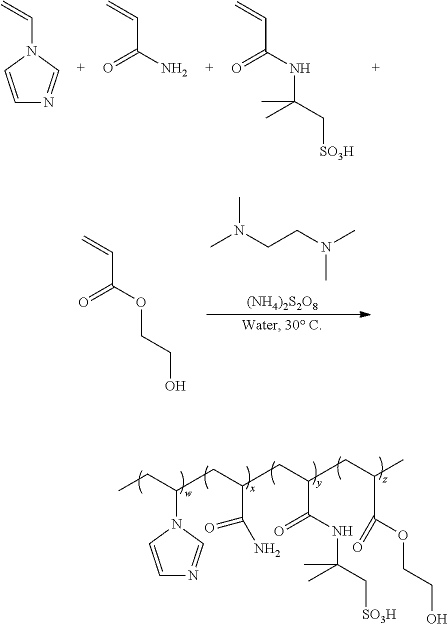

Synthesis of Polymer PAVAL (CLC-5): A water (120 mL) solution of vinyl imidazole (7.8 g), acrylic amide (6.0 g), 2-acrylamido-2-methyl-1-propanesulfonic acid (8.74 g), and 2-hydroxyethyl acrylate (9.74 g), tetramethylethylenediamine (0.1 mL) was degassed for 30 min. Then 0.05 g ammonium persulfate was added to the solution as initiator. The solution was degassed for additional 5 min at room temperature, then the whole was slowly heated to 30° C. and stirred for 30 min under argon atmosphere. The resulting solution was dropped into ethanol (2500 mL) to form white precipitate. The mixture was stirred overnight, then filtration to collect the solid, which was dried under vacuum to remove solvents. The resulted solid was redissolved in distilled water (150 mL) again, then dropped into ethanol (2500 mL). The mixture was stirred overnight, and the white precipitate was collected by filtration. After dried under vacuum, 12 gram of white solid was obtained in 50% yield. ¹H NMR (D₂O, 400 MHz) δ 8.0-8.8 (bs, 1H), 7.0-7.8 (bm, 5H), 3.9-4.4 (bm, 1H), 3.0-3.5 (m, 3H), 1.1-2.3 (m, 34H). Mw: 72,800 D.

### Example 1.1.7: Synthesis of Crosslinker Compound #6 (CLC-6 [PAVES])

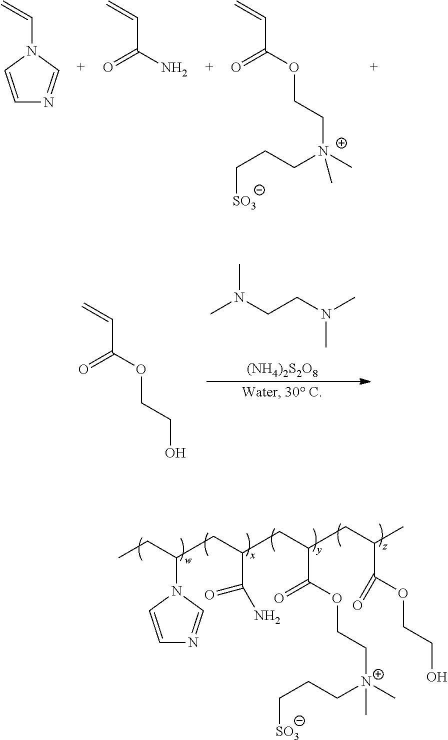

Synthesis of Polymer PAVES (CLC-6): A water (120 mL) solution of vinyl imidazole (7.8 g), acrylic amide (6.0 g), [2-(Methacryloyloxy)ethyl]dimethyl-(3-sulfopropyl)ammonium hydroxide (11.72 g), and 2-hydroxyethyl acrylate (9.74 g), tetramethylethylenediamine (0.1 mL) was degassed for 30 min. Then 0.05 g ammonium persulfate was added to the solution as initiator. The solution was degassed for additional 5 min at room temperature, then the whole was slowly heated to 30° C. and stirred for 30 min under argon atmosphere. The resulting solution was dropped into ethanol (2500 mL) to form white precipitate. The mixture was stirred overnight, then filtration to collect the solid, which was dried under vacuum to remove solvents. The resulted solid was redissolved in distilled water (150 mL) again, then dropped into ethanol (2500 mL). The mixture was stirred overnight, and the white precipitate was collected by filtration. After dried under vacuum, 15 gram of white solid was obtained in 60% yield. ¹H NMR (D₂O, 400 MHz) δ 7.1^{˜}7.6 (bm, 3H), 3.6 (m, 6H), 3.1 (bs, 8H), 2.90 (m, 2H), 1.2^{˜}2.4 (m, 18H).

### Comparative Example 2.1.1: Preparation of Comparative Membranes

For Comparative Example 2.1.1, comparative membrane (CE1), CE-1 was a polyamide reverse osmosis membrane (ESPA-2) secured from Hydranautics (Oceanside, Calif., USA).

### Example 2.1.2: Preparation of a Coated Membrane of GO and CLC-1 by Mixture Coating

For Example 2.1.2, the GO preparation was made in the same manner as Example 1.1.1, above.

GO-Crosslinker Application/Mixture Coating Method (Dip Coating): The GO dispersion, GC-1, was diluted with DI water to create a 0.03 wt % GO aqueous solution. A 1.2 wt % CLC-1 aqueous solution was made by dissolving appropriate amounts of CLC-1 in DI water. Then, a coating solution was made by mixing the aqueous solutions of 1.2 wt % CLC-1 and 0.03 wt % GO at a weight ratio of 19:1. The resulting coating solution was then sonicated for about 6 minutes. The result will then be a coating mixture.

The solution was then manually cast on an ESPA-2 reverse osmosis membrane (Hydranautics, Oceanside, Calif., USA) using a stainless steel 2-path (Bird-type) coating applicator (Paul N. Gardner Co., Inc., Pompano Beach, Fla., USA) set at a 5 mm clearance. The casting was dried at room temperature for about 3 hours to produce a coated ESPA-2 membrane.

The resulting membrane was kept in an oven (DX400, Yamato Scientific) at 110° C. for 3 min to facilitate further crosslinking. The result was a crosslinked GO coated polyamide membrane.

### Example 2.1.3: Preparation of a Coated Membrane of GO, CLC-5 and KBO [GO/PAVAL (1)] by Mixture Coating

The 2.18 mL 0.40% GO dispersion, GC-1, was diluted with 5.8 mL DI water. To the diluted GO solution, 1.79 mL of 2.5 wt % CLC-5 [PAVAL] aqueous solution and 0.23 mL of 1.0 wt % K₂B₄O₇ [KBO] solution were added. The resulting coating solution was then sonicated for about 6 minutes. The result will then be a coating mixture.

The solution was then manually cast on a ESPA-2 reverse osmosis membrane (Hydranautics, Oceanside, Calif., USA) using a stainless steel 2-path (Bird-type) coating applicator (Paul N. Gardner Co., Inc., Pompano Beach, Fla., USA) set at a 100 um clearance. The casting was dried at room temperature for about 3 hours to produce a coated ESPA-2 membrane.

The resulting membrane was kept in an oven (DX400, Yamato Scientific) at 110° C. for 3 min to facilitate further crosslinking. The result was a crosslinked GO coated polyamide membrane (GO/PAVAL (1)).

### Example 2.1.4: Preparation of a Coated Membrane of GO, CLC-5, KBO and Sericin [GO/PAVAL (2)] by Mixture Coating

The 2.18 mL 0.40% GO dispersion, GC-1, was diluted with 7 mL DI water. To the diluted GO solution, 1.79 mL 2.5 wt % CLC-5 [PAVAL] aqueous solution, 0.23 mL 1.0 wt % KBO solution and 0.093 mL 2.5 wt % sericin aqueous solution were added. The resulting coating solution was then sonicated for about 6 minutes. The result will then be a coating mixture.

The solution was then manually cast on a ESPA-2 reverse osmosis membrane (Hydranautics, Oceanside, Calif., USA) using a stainless steel 2-path (Bird-type) coating applicator (Paul N. Gardner Co., Inc., Pompano Beach, Fla., USA) set at a 150 um clearance. The casting was dried at room temperature for about 3 hours to produce a coated ESPA-2 membrane.

The resulting membrane was kept in an oven (DX400, Yamato Scientific) at 110° C. for 3 min to facilitate further crosslinking. The result was a crosslinked GO coated polyamide membrane (GO/PAVAL (2)).

### Example 3.1: Membrane Characterization

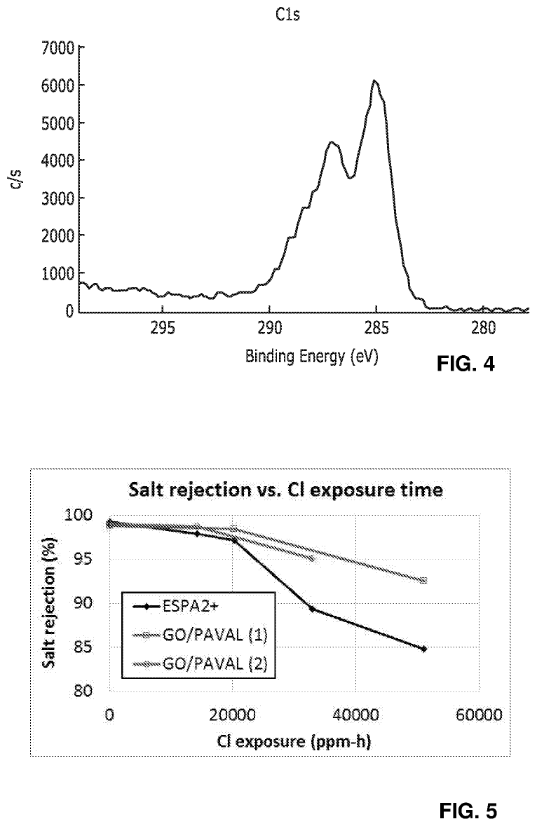

XPS Analysis: Membrane with crosslinked GO coating was be analyzed by X-ray photoelectron spectroscopy (XPS) to determine the relative distribution of the atomic spectra. The procedures for XPS are similar to those known by those skilled in the art. A CLC-1 (GO-PAAVA) membrane as described in Example 1.1.2 above was soaked in a 300 ppm solution of NaCl for 100 hours. XPS analysis was performed on the selected membrane before and after the soaking. The results are shown in Table 1 and FIGS. 3 and 4. The results show that chlorine is being bound to the coating layer, removing the chlorine from the feed solution.

TABLE 1
Atom Ratio of crosslinked GO coating by XPS Analysis

| GO/PAAVA | C | N | O | Cl |
|---|---|---|---|---|
| Before Cl | 71.2 | 2.4 | 26.4 | — |
| soaking | | | | |
| After Cl | 62.6 | — | 33.7 | 0.9 |
| soaking | | | | |

XRD Analysis: The basic crosslinked GO membrane structure in the representative devices will be characterized by X-ray Diffraction (XRD). The d-spacing of the lattice can be calculated by Bragg equation: 2d sin θ=nλ, which will show the interlayer distance of the crosslinked GO. It is thought that the crosslinked GO will have a larger interlayer distance than non-crosslinked GO.

IR Analysis: An infrared (IR) analysis of GO crosslinker structure will be undertaken. The IR analysis was done using methods known by those skilled in the art. The IR analysis will be used to indicate the formation of C—N bonds, as well as N—H bonds to verify whether crosslinking as occurred.

### Example 4.1: Reverse Osmosis Performance Testing of Selected Membranes

Water Flux and Salt Rejection Testing:

To test the salt rejection capability of the tested membranes, sodium chloride 1500 ppm solutions were passed through an uncoated EPSA-2 brand reverse osmosis membrane (Hydranautics, Oceanside, Calif., USA) (CE-1) and a coated membrane (CLC-1) at room temperature at 225 psi. Water flux and salt rejection measurements were taken at 30 minutes from the first exposure to such salt solutions. As seen in Table 2, the membranes demonstrated high NaCl salt rejection and good water flux.

CI-Resistance Test:

To test the CI-resistance of selected membrane, the membrane was soaked with a solution of 300 ppm sodium hypochlorite and 500 ppm CaCl₂ solution for certain period of time, then the membrane was cleaned with deionized water and tested for NaCl rejection and water flux using reverse osmosis cell testing method as described above. The results are shown in Table 2, Table 3 and FIG. 5.

TABLE 2
Performance of Cl-Resistance of
GO Coated Polyamide Membranes.

| | | CE-1, | | GO/CLC-1, | |
|---|---|---|---|---|---|
| | | @225 psi w/salt | | @225 psi w/salt | |
| | | NaCl | Flux | NaCl | Flux |
| Cl exposure time | | rejection (%) | (GFD) | rejection (%) | (GFD) |
| 0 | ppm*h | 98.3 | 11.8 | 98.65 | 12.0 |
| 3200 | ppm*h | 99.0 | 18.4 | | |
| 4900 | ppm*h | 99.0 | 19.1 | 98.7 | 10.5 |
| 13000 | ppm*h | 98.7 | 17.4 | 99.34 | 12.0 |
| 33000 | ppm*h | 97.1 | 21.3 | 97.69 | 16.5 |

TABLE 3
Performance of Cl-Resistance of GO Coated Polyamide Membranes.

| | | | | GO/PAVAL/KBO/sericin | | GO/PAVAL/KBO | |
|---|---|---|---|---|---|---|---|
| | | Uncoated RO membrane | | (@225 psi with salt) | | (@225 psi with salt) | |
| | | (@225 psi w/salt) CE-1 | | Wt Ratio: 15/77/4/4 | | Wt ratio: 16/80/4 | |
| | | n/a | | Coating thickness: 700 nm | | Coating thickness: 700 nm | |
| | | | Flux | | Flux | | Flux |
| Cl exposure | | rejection | (gfd) | rejection | (gfd) | rejection | (gfd) |
| 0 | ppm*h | 99.2% | 38.1 | 98.8% | 13.1 | | |
| 8000 | ppm*h | 97.9% | 19.3 | 98.3% | 7.0 | 99.2% | 20.5 |
| 13000 | ppm*h | 98.7% | 18 | 99.1% | 17.5 | 98.9% | 17.5 |
| 33000 | ppm*h | | | | | | |

From the data collected, it was shown that the coated GO with crosslinker membrane embodiments performed better than uncoated GO membranes in terms of salt rejection after long period of chlorine exposure in the feed solution.

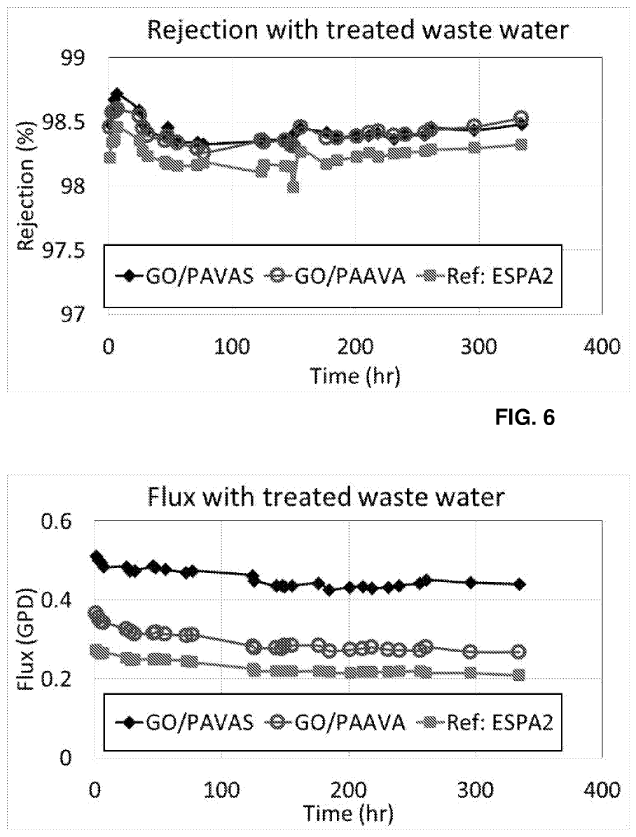

To test the fouling resistance of a selected membrane, the membrane was mounted in a crossflow cell test system and exposed to a water discharged from waste water treatment plant for certain period of time. The NaCl rejection and water flux performance data was collected from time to time to evaluate the fouling resistance of the membrane. From the data collected, see FIGS. 6 and 7, the crosslinked GO coated polyamide membrane performed much better than uncoated polyamide membrane in terms of both water flux and NaCl rejection. Particularly, the membrane with GO/PAVAS coated polyamide membrane has much higher water flux and slower flux decline comparing with uncoated polyamide membrane (ESPA2).

1.-21. (canceled)

22. A reverse osmosis membrane structure, comprising:
a membrane comprising a polyamide layer; and
a composite coating disposed upon the membrane;
wherein the composite coating comprises a crosslinked graphene oxide which is a product of reacting a mixture comprising a graphene oxide and a copolymer crosslinker; and
wherein the copolymer crosslinker comprises at least an optionally substituted vinyl imidazolyl constituent unit and an optionally substituted acrylic amide constituent unit.

23. The structure of claim 22, wherein the composite coating is resistant to chlorine-based oxidants.

24. The structure of claim 22, wherein the copolymer crosslinker further comprises an optionally substituted acrylic acid constituent unit, an optionally substituted acrylate constituent unit or a combination thereof.

25. The structure of claim 22, wherein the optionally substituted vinyl imidazole constituent unit is represented by the formula:

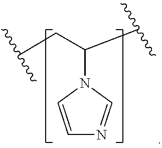

26. The structure of claim 22, wherein the optionally substituted vinyl imidazolyl constituent unit comprises a sulfonated vinyl imidazole.

27. The structure of claim 22, wherein the optionally substituted vinyl imidazole constituent unit is represented by the formula: 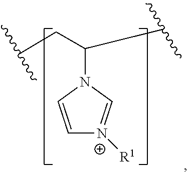
wherein R¹ is C₁₋₄ hydrocarbylsulfate.

28. The structure of claim 27, wherein R¹ is:

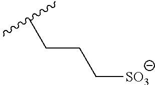

29. The structure of claim 22, wherein the optionally substituted acrylic amide constituent unit is represented by the formula: 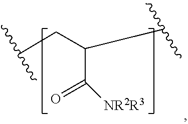
wherein R² and R³ are independently H, optionally substituted C₁₋₈ hydrocarbyl, C₁₋₈ sulfonated hydrocarbylammoniumhydrocarbyl, or optionally substituted C₁₋₈ sulfonated hydrocarbyl.

30. The structure of claim 29, wherein R² and R³ are independently H,

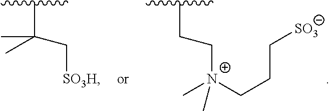

31. The structure of claim 22, wherein the crosslinker comprises an optionally substituted acrylate constituent unit of the formula: 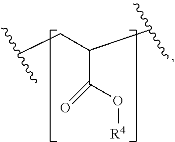
wherein R⁴ is H, —CH₂CH₂OH, —CH₂CH₂CH₂OH, —CH₂CH₂CH₂CH₂OH, or

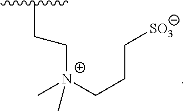

32. The structure of claim 22, wherein the crosslinker comprises an optionally substituted acrylate constituent unit of the formula: 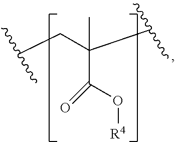
wherein R⁴ is H, —CH₂CH₂OH, —CH₂CH₂CH₂OH, —CH₂CH₂CH₂CH₂OH, or

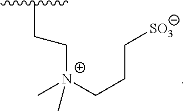

33. The structure of claim 22, wherein the copolymer crosslinker comprises:

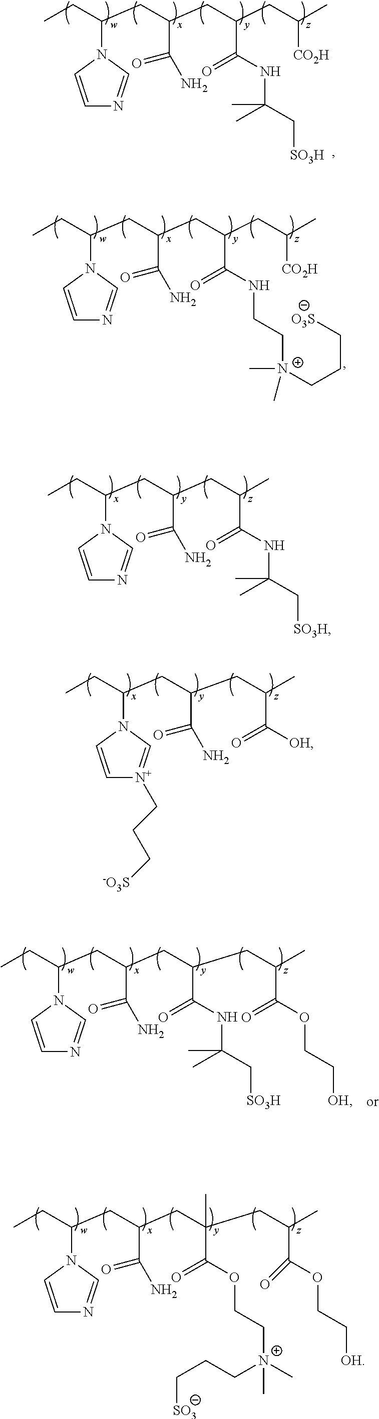

34. The structure of claim 22, wherein the graphene oxide comprises platelets, wherein the platelets are between about 0.05 μm and about 50 μm.

35. The structure of claim 22, wherein the graphene oxide and crosslinking polymer in the composite has a weight ratio value of about 1:90 wt %.

36. The structure of claim 22, wherein the composite coating further comprises a borate salt, a tetraethyl orthosilicate, an optionally substituted aminoalkylsilane, silica nanoparticles, polyethylene glycol, trimesic acid, 2,5-dihydroxyterephthalic acid, CaCl₂, or a combination thereof.

37. The structure of claim 36, wherein the borate salt comprises K₂B₄O₇, Li₂B₄O₇ or Na₂B₄O₇.

38. The structure of claim 36, wherein the borate salt is about 0.001 wt % to about 20 wt % of the composite.

39. The structure of claim 22, wherein the composite further comprises an acid additive, wherein the acid additive comprises hydrochloric acid, sulfuric acid, camphor sulfuric acid, or a combination thereof, and wherein the acid additive is about 0.001 wt % to about 10 wt % of the composite.

40. The structure of claim 22, wherein the composite further comprises a biopolymer, wherein the biopolymer comprises sericin.

41. A method of desalinating water comprising applying a saline water to the membrane of claim 22, wherein the saline water comprises a salt and water, wherein the saline water is applied to the membrane so that some of the water passes through the membrane to yield water with a lower salt content.
